(19) United States
(12) Patent Application Publication
(10) Pub. No.: US 2005/0234595 A1
(43) Pub. Date: Oct. 20, 2005

(54) Self-propelled cleaner and method of controlling the same

(75) Inventor: Takao Tani, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/107,286

(22) Filed: Apr. 15, 2005

(30) Foreign Application Priority Data
Apr. 16, 2004 (JP) JP2004-121844

(51) Int. Cl. G06F 19/00

(52) U.S. Cl. 700/245

(57) ABSTRACT

In a cleaner, it is determined whether or not a remaining volume of a battery is equal to or more than a sum of a battery volume required for returning to a position of a battery charger and a predetermined allowance value. When the remaining volume of the battery is determined to be equal to or more than the sum, a control unit supplies a current during 80% of a predetermined time length to a left drive wheel motor and a right drive wheel motor and halts the supply of the current during 20% of the predetermined time length. When the remaining volume of the battery is determined to be below the sum, the control unit supplies the current during 40% of the predetermined time length to the left drive wheel motor and the right drive wheel motor and halts the supply of the current during 60% of the predetermined time length.

### BACKGROUND OF THE INVENTION

1. Field of the Invention

The present invention relates to a self-propelled cleaner and a method of controlling the cleaner. More particularly, the present invention relates to a self-propelled cleaner for cleaning a space to be cleaned through an autonomous travel, and a method of controlling the cleaner.

2. Description of the Background Art

Conventionally, a self-propelled cleaner capable of storing a traveling path has been available. Further, in an example of the self-propelled cleaner, a traveling distance between a present position and a charging position is calculated, a remaining volume of a battery is detected, and the cleaner is controlled so that it returns to a charging stand when the remaining volume of the battery approximates to a volume of the battery required for the traveling from the present position to the charging position, as recited in Japanese Patent Laying-Open Nos. 7-8428 and 2002-318620.

The foregoing documents relating to the conventional technology recited that the “control for returning to the charging stand” was such a control that a destination of the traveling was changed to the charging stand, wherein there was no discussion on a traveling mode after the destination was changed to the charging stand.

### SUMMARY OF THE INVENTION

The present invention has been implemented in order to deal with the foregoing disadvantage, and an object thereof is to enable a self-propelled cleaner to unfailingly return to a charging stand even when the remaining volume of a battery is lessened to some extent.

A self-propelled cleaner according to an aspect of the present invention includes a traveling unit, a traveling drive unit for driving the traveling unit and allowing the cleaner to autonomously travel, a suction unit for implementing a suction operation for cleaning, a power supply for supplying the traveling drive unit and the suction unit with a current, a control unit for controlling modes of supplying the current to the traveling drive unit and the suction unit from the power supply, and a voltage detecting unit for detecting a voltage of the power supply. Herein, when a voltage value detected by the voltage detecting unit is below a predetermined value, the control unit makes a length of time for supplying the traveling drive unit with the current within a predetermined length of time shorter than a length of time when the voltage value detected by the voltage detecting unit is equal to or more than the predetermined value.

A self-propelled cleaner according to another aspect of the present invention includes a traveling unit, a traveling drive unit for driving the traveling unit and allowing the cleaner to autonomously travel, a suction unit for implementing a suction operation for cleaning, a power supply for supplying the traveling drive unit and the suction unit with a current, and a control unit for controlling modes of supplying the current to the traveling drive unit and the suction unit from the power supply. Herein, the control unit supplies the traveling drive unit with a current value lower than a current value demanded by the suction unit for its suction operation in order to drive the traveling unit.

A method of controlling a self-propelled cleaner according to the present invention is a method of controlling a self-propelled cleaner including a traveling unit, a traveling drive unit for driving the traveling unit and allowing the cleaner to autonomously travel, a suction unit for implementing a suction operation for cleaning, and a power supply for supplying the traveling drive unit and the suction unit with a current. Herein, the method includes a step of detecting a voltage of the power supply, a step of determining whether or not the voltage of the power supply is equal to or more than a predetermined value, a step of supplying the traveling drive unit with the current during a first length of time within a predetermined time length when the voltage of the power supply is equal to or more than the predetermined value, and a step of supplying the traveling drive unit with the current during a second length of time shorter than the first length of time within the predetermined time length when the voltage of the power supply is below the predetermined value.

According to the present invention, when the voltage value of the power supply is below the predetermined value, the current value required for the traveling can be controlled. Accordingly, the self-propelled cleaner can reliably return to the charging stand even when the remaining volume of the power supply is lessened to some extent because the cleaner can travel in a relatively long length of time.

Further, according to the present invention, the current value required for the traveling is set to the value lower than the current value required for the suction and thereby controlled. Accordingly, the self-propelled cleaner can reliably return to the charging stand even when the remaining volume of the power supply is lessened to some extent because the cleaner can travel in a relatively long length of time.

A self-propelled cleaner according to the present invention includes a traveling unit, a traveling drive unit for driving the traveling unit and allowing the cleaner to autonomously travel, a suction unit for implementing a suction operation for cleaning, a power supply for supplying the traveling drive unit and the suction unit with a current, a control unit for controlling modes of supplying the current to the traveling drive unit and the suction unit from the power supply, and a voltage detecting unit for detecting a voltage of the power supply. The current value necessarily supplied to the traveling drive unit for driving the traveling unit is lower than the current value necessarily supplied to the suction unit for its suction operation, and the control unit, when the voltage value detected by the voltage detecting unit is below the predetermined value, shortens the length of time for supply the traveling drive unit with the current within the predetermined length of time in comparison with the case of the voltage value being equal to or more than the predetermined value. The power supply is rechargeable when it is connected to the battery charger. A path calculating section for calculating a path from the present position of the power supply to the battery charger is further included. The predetermined value is based on a voltage value required for traveling the path from the present position of the power supply to the battery charger calculated by the path calculating section.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a self-propelled cleaner according to an embodiment of the present invention;

FIG. 2 shows a lower surface of the cleaner of FIG. 1;

FIG. 3 is a sectional view of the cleaner taken along line III-III of FIG. 1;

FIG. 4 is a block diagram of the cleaner of FIG. 1 and a battery charger for charging a battery of the cleaner;

FIGS. 5A and 5B are illustrations of modes of controlling a voltage with respect to a left drive wheel motor and a right drive wheel motor of the cleaner of FIG. 1;

FIGS. 6A and 6B are illustrations of modes of controlling a current with respect to the left drive wheel motor and the right drive wheel motor of the cleaner shown in FIG. 1;

FIG. 7 is a perspective view of a modification of the cleaner of FIG. 1;

FIG. 8 shows a lower surface of the cleaner of FIG. 7; and

FIG. 9 is a block diagram of the cleaner of FIG. 7 and a battery charger for charging a battery of the cleaner.

### DESCRIPTION OF THE PREFERRED EMBODIMENTS

Hereinafter, an embodiment of the present invention will be described referring to the drawings.

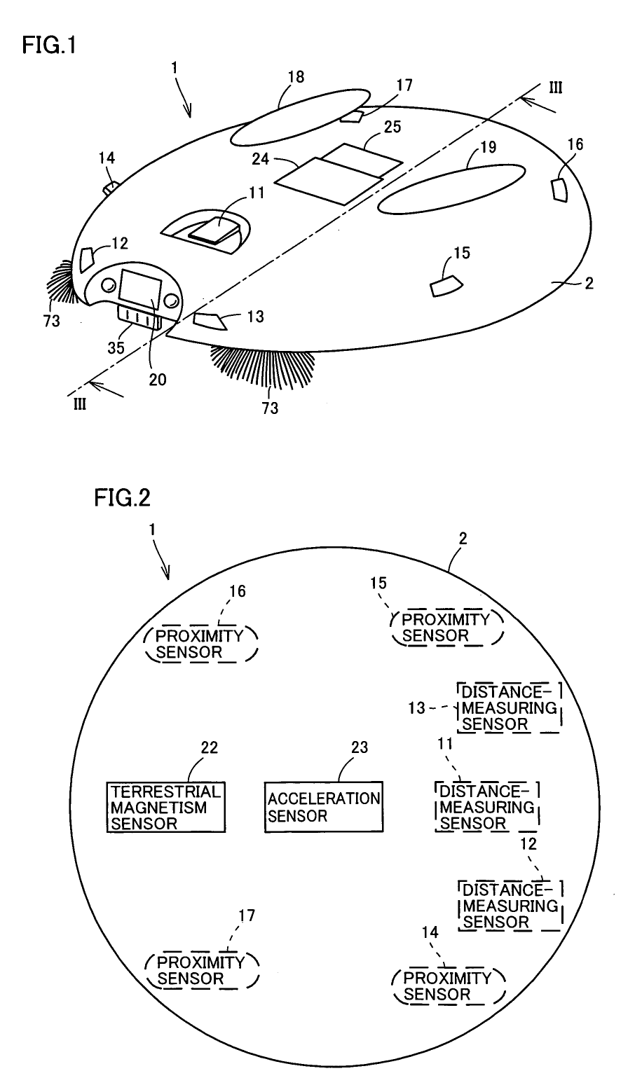

Referring to FIG. 1, a cleaner 1, whose exterior part is covered with a outer jacket 2, has a substantially disk shape. On outer jacket 2, antennas 18 and 19, a display unit 24, an input unit 25, proximity sensors 14 to 17, and distance-measuring sensors 11 to 13 are provided. Input unit 25 is constituted of a switch and the like and used by a user when he/she inputs information to cleaner 1. A surface, which is nearly vertical in part, is formed in a frontal surface of outer jacket 2, and a camera 20 is disposed on the surface. Below camera 20 is provided an LED (Light Emitting Diode) 35 for supplementing an illumination when photographing is carried out by means of camera 20. In a forward direction of cleaner 1 and on a lower side of outer jacket 2, side brushes 73 are each provided on right and left.

Next, referring to FIG. 2, the sensors installed in cleaner 1 will be described. In FIG. 2, some of the components, such as side brushes 73 and LED 35, are not shown.

Cleaner 1 is further provided with an acceleration sensor 23 and a terrestrial magnetism sensor 24. As seen in FIGS. 1 and 2, proximity sensors 14 to 17 are each disposed in front, rear, right and left of cleaner 1.

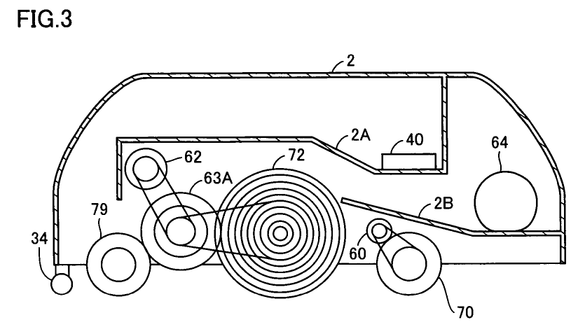

Referring to FIG. 3, an internal structure of cleaner 1 will be described. Support plates 2A and 2B are disposed inside of outer jacket 2. A control basement 40, in which parts for controlling an operation of cleaner 1 are packaged, is disposed on support plate 2A. In a substantially central portion of cleaner 1, a main brush 72 for raking up dust on a floor surface by rotation is disposed. A main brush motor 62 is driven and a driving force resulting therefrom is conveyed via a gear 63A, which rotates main brush 72. The dust raked up by main brush 72 is collected in a dust-collecting cup (not shown). When a suction motor 64 is driven, the raked-up dust is guided into the dust-collecting cup via a nozzle (not shown). Suction motor 64 is disposed on support plate 2B.

In FIG. 3, a left drive wheel 70 is shown. Cleaner 1 is provided with drive wheels, which are left drive wheel 70 and a right drive wheel (not shown), each disposed on right and left. Cleaner 1 starts to travel when the two drive wheels are driven. Left drive wheel 70 is driven in response to a left drive wheel motor 60 being driven. Cleaner 1 is further provided with auxiliary wheels respectively disposed behind the right and left drive wheels. An auxiliary wheel 79 is provided behind left drive wheel 70. At a rearmost part of cleaner 1, a dust sensor 34 is provided. Dust sensor 34 is a unit including an infrared-ray sensor serving to detect an amount of dust on the floor surface.

Cleaner 1 operates using a rechargeable battery (battery 30 which will be described later) as a power source.

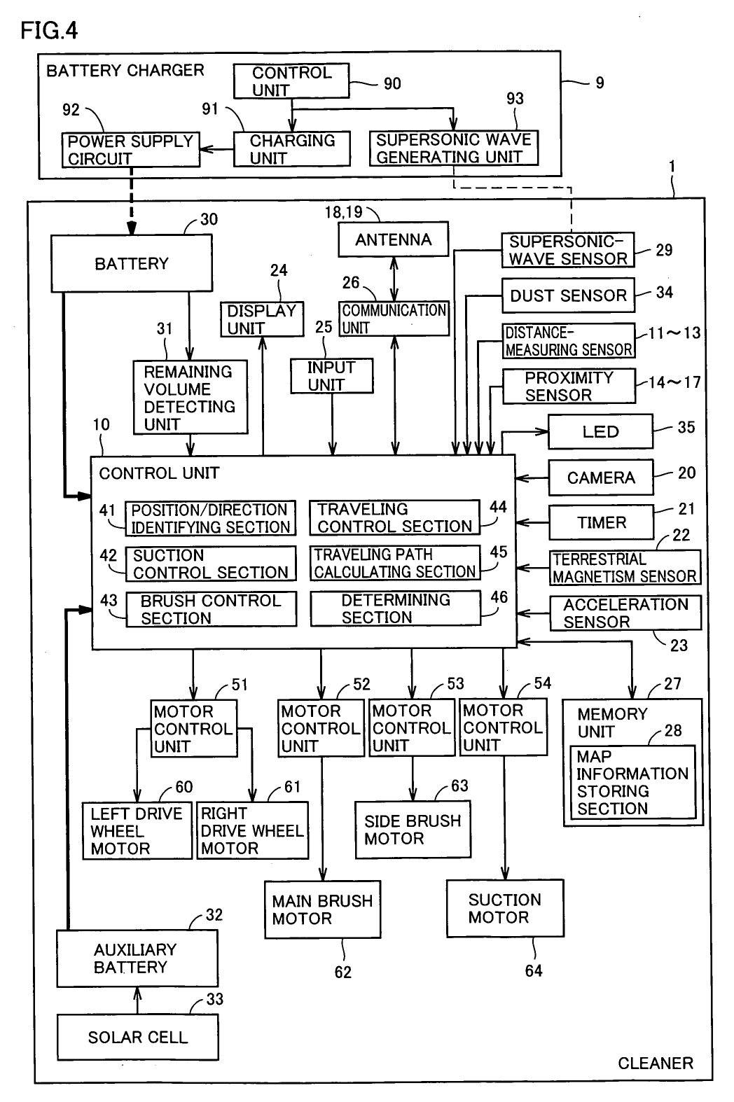

Referring to FIG. 4, constitutions of cleaner 1 and a battery charger 9 for charging the battery will be described.

Cleaner 1 includes battery 30.

Battery charger 9 includes a control unit 90 for generally controlling an operation of battery charger 9, a charging unit 91 for controlling a charging operation with respect to battery 30, a power supply circuit 92 connected to battery 30 by a connector or the like and thereby serving to charge battery 30, and a supersonic wave generating unit 93 for outputting a supersonic-wave signal. Battery charger 9 is supplied with an alternating-current power supply such as a commercial-use power supply. Power supply circuit 92 converts alternative-current power supplied by battery charger 9 into direct-current power to thereby charge battery 30. A remaining volume detecting unit 31 for detecting a voltage of battery 30 is connected to battery 30.

Cleaner 1 includes a control unit 10 for generally controlling the operation of cleaner 1. Control unit 10 includes a position/direction identifying section 41, a suction control section 42, a brush control section 43, a traveling control section 44, a traveling path calculating section 45 and a determining section 46.

Control unit 10 is connected to motor control units 51 to 54. Motor control unit 51 controls the drives of left drive wheel motor 60 and right drive wheel motor 61. Left drive wheel motor 60 serves to drive left drive wheel 70, while right drive wheel motor 61 serves to drive the right drive wheel. Motor control unit 52 controls the drive of main brush motor 62. Motor control unit 53 controls the drive of a side brush motor 63. Side brush motor 63 serves to drive side brush 73. Motor control unit 54 controls the drive of suction motor 64.

The information inputted to input unit 25 is inputted to control unit 10. Further, detection outputs of remaining volume detecting unit 31, dust sensor 34, distance-measuring sensors 11 to 13, proximity sensors 14 to 17, terrestrial magnetism sensor 22 and acceleration sensor 23 are inputted to control unit 10.

Further, image data captured by camera 20 is inputted to control unit 10, and control unit 10 can reference time counted by a timer 21 provided in the cleaner and further control operations of display unit 24 and LED 35.

Cleaner 1 is further provided with a communication unit 26 for communicating with other devices. Control unit 10 can communicate with other devices via communication unit 26 and antennas 18 and 19.

Cleaner 1 is further provided with an auxiliary battery 32 and a solar cell 33. In cleaner 1, auxiliary battery 32 can be charged utilizing light irradiated on solar cell 33. Cleaner 1 can also be operated by means of power supplied by auxiliary battery 32.

Control unit 10 is connected to a memory unit 27. In memory unit 27, a map information storing section 28, in which positional coordinates representing a size and a shape of each of a plurality of rooms as operational areas of cleaner 1, map information of entrance/exit coordinates of the each room and cleaning pattern information and the like of the each room are stored, is formed.

Position/direction identifying section 41 calculates a position, a moving amount and a moving direction of cleaner 1 based on detection outputs of terrestrial magnetism sensor 22 and acceleration sensor 23 and modes of driving left drive wheel motor 60 and right drive wheel motor 61 by motor control unit 51 and identifies a present position and a traveling direction of cleaner 1 from the calculated position, moving amount, moving direction and map information stored in map information storing section 28.

Traveling path calculating section 45 calculates a traveling path from the present position identified by position/direction identifying section 41 to a position of battery charger 9 (more specifically, position stored in map information storing section 28, at which battery 30 is connected to the above-mentioned connector and thereby charged by power supply circuit 92).

Determining section 46 calculates a battery volume (voltage value) required for cleaner 1 to return to the position of battery charger 9 in accordance with the traveling path calculated by traveling path calculating section 45 and compares the calculated battery volume to a remaining volume (voltage value) of battery 30 detected by remaining volume detecting unit 31 to thereby determine whether or not cleaner 1 is allowed to travel back to the position of battery charger 9. More specifically, determining section 46 renders the decision that cleaner 1 travels to return to battery charger 9 when the remaining volume of the of battery 30 falls below a sum of the battery volume required for returning to the position of battery charger 9 and a predetermined allowance volume.

Traveling control section 44 controls motor control unit 51 based on the present position identified by position/direction identifying section 41 and the map information stored in map information storing section 28. Cleaner 1 is allowed to autonomously travel because traveling control section 44 can control operations of the right and left drive wheels based on the present position and the map information.

Suction control section 42 and brush control section 43 respectively drive motor control unit 54 and motor control unit 53 during a period when the cleaning should be carried out based on the present position and the map information stored in map information storing section 28.

As described, cleaner 1 can autonomously travel and arrive at the position of battery charger 9 basically without any guidance because it is configured to travel based on the map information stored in map information storing section 28. Cleaner 1 is accessorily provided with a supersonic-wave sensor 29 for the guidance to the position of battery charger 9. Supersonic-wave sensor 29 can receive a supersonic wave outputted by the supersonic-wave generating unit 93. A reception intensity of the supersonic wave in supersonic-wave sensor 29 is inputted to control unit 10. Control unit 10 can recognize if cleaner 1 is approaching or moving away from battery charger 9 based a variation of the reception intensity of the supersonic wave in supersonic-wave sensor 29 during the traveling. In other words, the provision of supersonic-wave sensor 29 can lead cleaner 1 to reliably arrive at the position of battery charger 9.

Cleaner 1 can start the cleaning operation when information for starting the cleaning is inputted to input unit 25. Cleaner 1 can carry out the cleaning operation based on the inputted information, for example, the cleaning operation in accordance with the cleaning patterns for the respective rooms stored in map information storing section 28. More specifically, motor control unit 51 is driven so that cleaner 1 moves in accordance with the cleaning patterns stored in map information storing section 28, motor control units 52 and 53 are driven so that the dust is raked up by main brush 72 and side brush 73, and motor control unit 64 is driven so that the raked-up dust is sucked into the dust-collecting cup.

In cleaner 1, a timer operation in which the cleaning can start at a designated time point can be optionally set. More specifically, when information for designating the cleaning-start time is inputted to input unit 25, cleaner 1 can commence the cleaning operation provided that the time counted by timer 21 falls on the designated time.

Further, cleaner 1 can carry out a security operation other than the cleaning operation. More specifically, when information for designating a time point when the security operation is implemented and a moving pattern is inputted to input unit 25, for example, cleaner 1 drives motor control unit 51 so as to move based on the designated moving pattern provided that the time counted by timer 21 falls on the designated time and carries out a cyclic operation. In implementing the security operation, when the presence or movement of an object, a person or the like which is not usually anticipated is detected by proximity sensors 14 to 17 and/or distance-measuring sensors 11 to 13, cleaner 1 can point camera 20 at the object or the person to thereby photograph it and transmit the captured image to a predetermined terminal disposed distantly from cleaner 1 via communication unit 26 and antennas 18 and 19.

In the embodiment so far described, in order for cleaner 1 to implement the cleaning operation, the right and left drive wheels are driven for the traveling, and main brush 72 and side brush 73 are rotated for the cleaning.

In order for the right and left drive wheels to be driven, a drive current (hereinafter, referred to as traveling drive current) is supplied to left drive wheel motor 60 and right drive wheel motor 61 under the controls of control unit 10 and motor control unit 51.

In order for main brush 72 and side brush 73 to be rotated, a drive current (hereinafter, referred to as cleaning drive current) is supplied to main brush motor 62 and side brush motor 63 under the controls of control unit 10 and motor control units 52 and 53.

In the case of cleaner 1 according to the present embodiment, members constituting the right and left drive wheels, main brush 72 and side brush 73 are selected so that the traveling drive current shows a value below a value of the cleaning drive current.

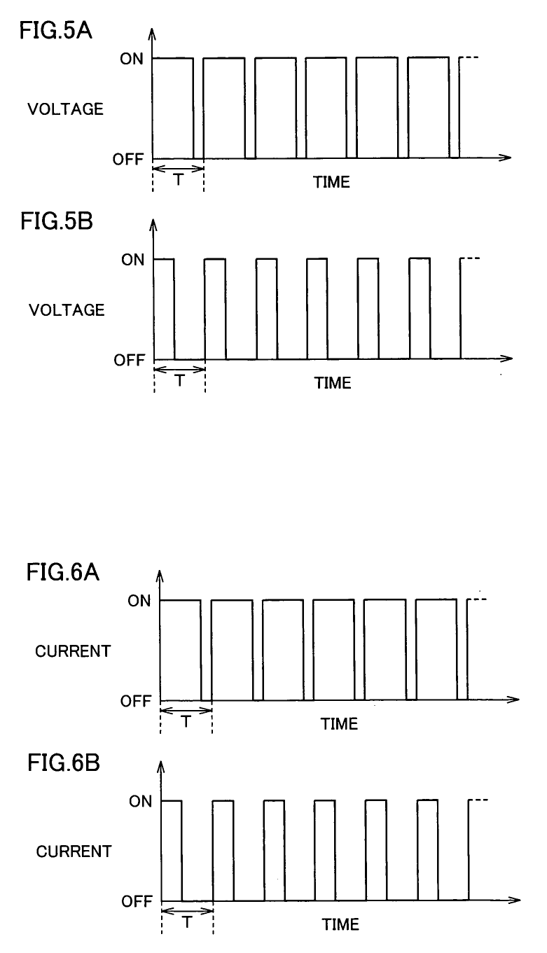

As described, in cleaner 1, it is determined by determining section 46 whether or not cleaner 1 is allowed to travel back to battery charger 9. In cleaner 1, when it is determined that cleaner 1 necessarily travels back to battery charger 9, an arrangement is made in order to control the power consumption required for the traveling in surely returning to the position of battery charger 9. When it is determined by determining section 46 that cleaner 1 is allowed to travel back to battery charger 9 during the time when cleaner 1 is performing the cleaning operation, a length of time for applying the voltage supplied to left drive wheel motor 60 and right drive wheel motor 61 per unit time is made shorter than a length of time before then, in other words, a length of time in the case in which the remaining volume of battery 30 is determined to be equal to or more than the sum of the battery volume required for returning to the position of battery charger 9 and the predetermined allowance volume. Thereby, the length of time for supplying the current to left drive wheel motor 60 and right drive wheel motor 61 per unit time is shortened. The modes of controlling the voltage and the current are described in detail referring to FIGS. 5A, 5B, 6A and 6B.

In cleaner 1, a PWM (Pulse Width Modulation) control is performed to left drive wheel motor 60 and right drive wheel motor 61.

When the remaining volume of battery 30 is determined to be equal to or more than the sum of the battery volume required for returning to the position of battery charger 9 and the predetermined allowance volume, the voltage is applied to left drive wheel motor 60 and right drive wheel motor 61, for example, in a mode shown in FIG. 5A. More specifically, the control is performed in such manner that the voltage is applied (ON state) during 80% of unit time T and the application of the voltage is halted (OFF state) during 20% thereof, and the control based on the unit time T is continuously repeated.

When the remaining volume of battery 30 is determined to be less than the sum of the battery volume required for returning to the position of battery charger 9 and the predetermined allowance value, the voltage is applied to left drive wheel motor 60 and right drive wheel motor 61, for example, in a mode shown in FIG. 5B. More specifically, the control is performed in such manner that the voltage is applied (ON state) during 40% of the unit time T and the application of the voltage is halted (OFF state) during 60% thereof, and the control based on the unit time T is continuously repeated.

When the voltage control as shown in FIG. 5A is performed, a current control as shown in FIG. 6A is performed to left drive wheel motor 60 and right drive wheel motor 61 because battery 30 is the direct-current power supply. More specifically, the control is performed in such manner that the current is applied (ON state) during 80% of the unit time T and the application of the current is halted (OFF state) during 20% thereof, and the control based on the unit time T is continuously repeated.

When the voltage control as shown in FIG. 5B is performed, a current control as shown in FIG. 6B is performed to left drive wheel motor 60 and right drive wheel motor 61. More specifically, the control is performed in such manner that the current is applied (ON state) during 40% of the unit time T and the application of the current is halted (OFF state) during 60% thereof, and the control based on the unit time T is continuously repeated.

Further, it is preferable that, in cleaner 1, a shortest path to battery charger 9 be selected as a result of referencing map information storing section 28 and/or a traveling path along a forward direction of a carpet, if the carpet is present in the traveling path, be selected in order to reduce the power consumption required for cleaner 1 to travel back to battery charger 9. It is a possible option to further provide a light volume sensor, wherein cleaner 1 is returned to battery charger 9 while auxiliary battery 32 is being charged by means of solar cell 33, and the path back to battery charger 9 is arranged to be a path in which a light reception volume of solar cell 33 is increased based on a detection output of the light volume sensor in order to increase the charge volume in charging auxiliary battery 32.

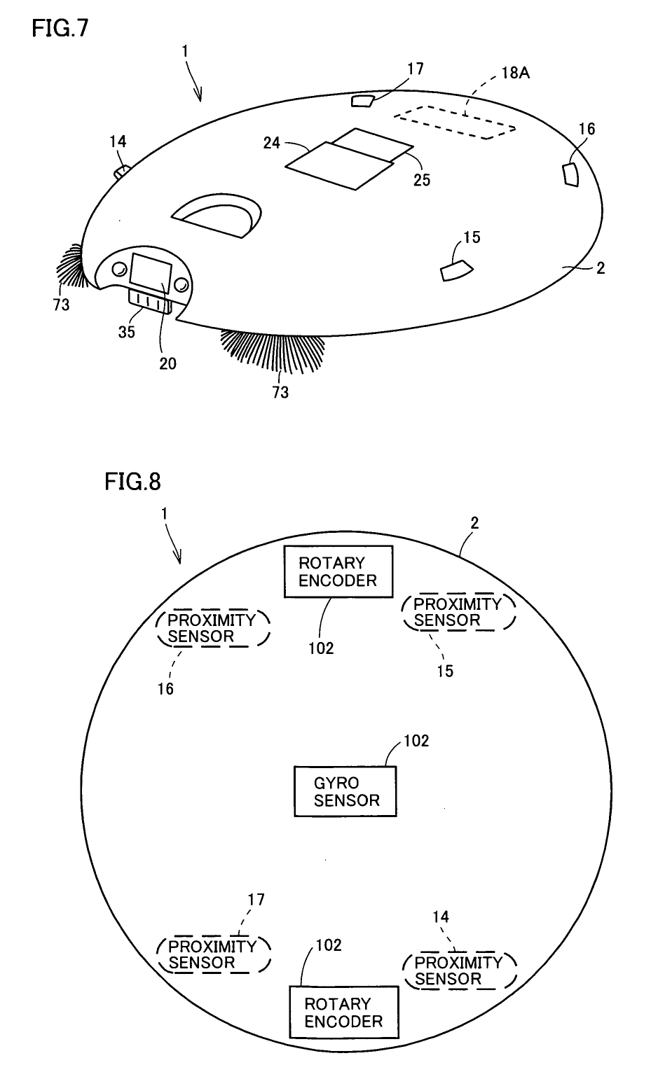

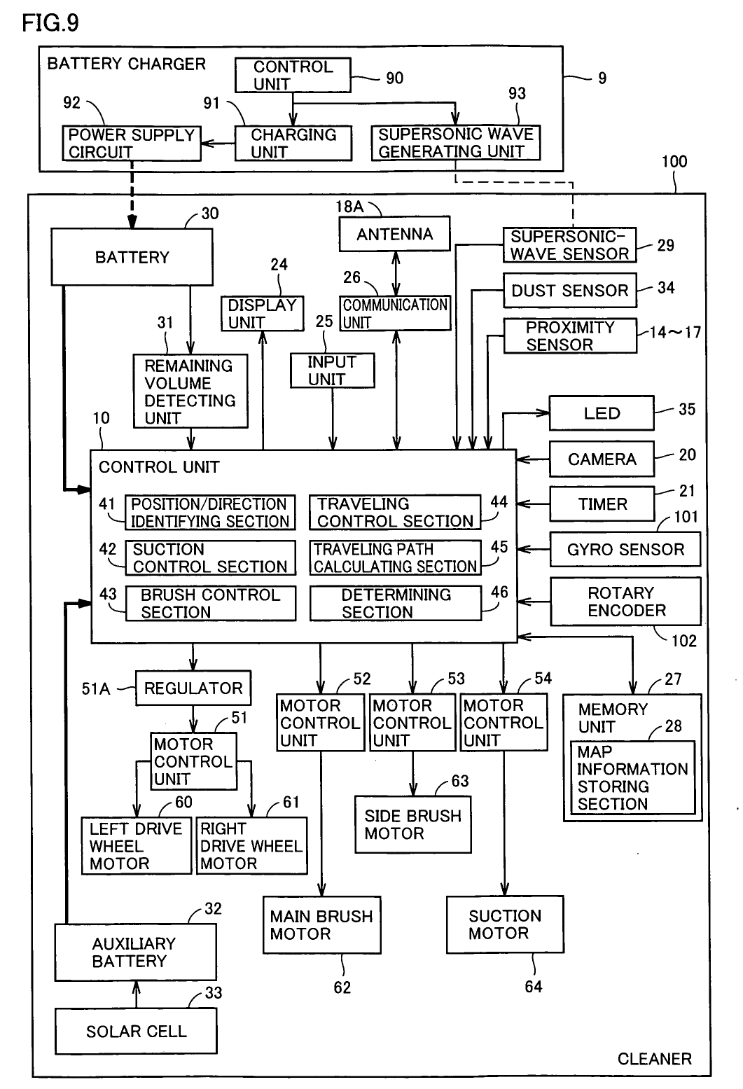

Further, cleaner 1 can be subjected to various modifications as shown in FIGS. 7 to 9. Hereinafter, a cleaner 100 shown in FIGS. 7 to 9 as a modification of cleaner 1 will be described referring the drawings.

Cleaner 100 includes, in place of antennas 18 and 19 provided in cleaner 1, an incorporated antenna 18A housed in an inner side than outer jacket 2.

Distance-measuring sensors 11 to 13 provided in cleaner 1 are omitted in cleaner 100. In cleaner 100, a distance to an object is measured by supersonic-wave sensor 29.

Further, cleaner 100 includes, in place of terrestrial magnetism sensor 22 provided in cleaner 1, a gyro sensor 101. In cleaner 100, an angle at which cleaner 100 is rotated is measured by gyro sensor 101, which serves to obtain an accurate angle even when any magnetized object such as a steel pole is present in the vicinity of cleaner 100. In cleaners 1 and 100, the function is utilized to accurately grasp the positions thereof particularly on the carpet.

Further, cleaner 100 includes, in place of acceleration sensor 23 provided in cleaner 1, a rotary encoder 102. Rotary encoder 102 includes a light emitting element and a light receiving element. A part of a right wheel or a left wheel of cleaner 100 is disposed between the light emitting element and the light receiving element of rotary encoder 102. The part of the wheel serves to allow the light receiving element to receive light emitted by the light emitting element at a predetermined pattern for each rotation of the wheel. Accordingly, it is possible for rotary encoder 102 to detect the number of the rotations of the right or left wheel in cleaner 100.

Further, in cleaner 100, a regulator 51A is connected between control unit 10 and motor control unit 51. The power can be thereby supplied to motor control unit 51 in a stable manner.

Although the present invention has been described and illustrated in detail, it is clearly understood that the same is by way of illustration and example only and is not to be taken by way of limitation, the spirit and scope of the present invention being limited only by the terms of the appended claims.

1. A self-propelled cleaner comprising:
a traveling unit;
a traveling drive unit for driving said traveling unit and allowing the cleaner to autonomously travel;
a suction unit for implementing a suction operation for cleaning,
a power supply for supplying said traveling drive unit and said suction unit with a current;
a control unit for controlling modes of supplying the current to said traveling drive unit and said suction unit from said power supply; and
a voltage detecting unit for detecting a voltage of said power supply, wherein
when a voltage value detected by said voltage detecting unit is below a predetermined value, said control unit makes a length of time for supplying said traveling drive unit with the current within a predetermined length of time shorter than a length of time when the voltage value detected by said voltage detecting unit is equal to or more than said predetermined value.

2. The self-propelled cleaner according to claim 1, wherein
said power supply is connected to a battery charger to thereby serve as a rechargeable battery,
the cleaner further comprises a path calculating section for calculating a path from a present position of said power supply to a position where said battery charger is present, and
said predetermined value is based on a voltage value required for traveling the path calculated by said path calculating section.

3. The self-propelled cleaner according to claim 2, wherein
said predetermined value is a sum of the voltage value required for traveling the path calculated by said path calculating section and a predetermined allowance value.

4. The self-propelled cleaner according to claim 3, wherein
said control unit supplies said traveling drive unit with a current value lower than a current value demanded by said suction unit for the suction operation thereof in order to drive said traveling unit.

5. A self-propelled cleaner comprising:
a traveling unit;
a traveling drive unit for driving said traveling unit and allowing the cleaner to autonomously travel;
a suction unit for implementing a suction operation for cleaning,
a power supply for supplying said traveling drive unit and said suction unit with a current; and
a control unit for controlling modes of supplying the current to said traveling drive unit and said suction unit from said power supply, wherein
said control unit supplies said traveling drive unit with a current value lower than a current value demanded by said suction unit for the suction operation thereof in order to drive said traveling unit.

6. The self-propelled cleaner according to claim 5, wherein
said power supply is connected to a battery charger to thereby serve as a rechargeable battery.

7. A method of controlling a self-propelled cleaner comprising a traveling unit, a traveling drive unit for driving the traveling unit and allowing the cleaner to autonomously travel, a suction unit for implementing a suction operation for cleaning, and a power supply for supplying said traveling drive unit and said suction unit with a current, the method comprising the steps of:
detecting a voltage of said power supply;
determining whether or not the voltage of said power supply is equal to or more than a predetermined value;
supplying said traveling drive unit with the current during a first length of time within a predetermined time length when the voltage of said power supply is equal to or more than the predetermined value; and
supplying said traveling drive unit with the current during a second length of time shorter than the first length of time within said predetermined time length when the voltage of said power supply is below the predetermined value.

8. The method of controlling the self-propelled cleaner according to claim 7, further comprising the step of:
calculating a path from a present position of said power supply to a position where said battery charger is present, wherein
said predetermined value is based on a voltage value required for traveling said calculated path in said determination step.
